(19) United States
(12) Patent Application Publication
(10) Pub. No.: US 2007/0238563 A1
(43) Pub. Date: Oct. 11, 2007

(54) Bicycle Gear Mechanism

(75) Inventors: Ermanno Righi, Modena (IT); Sandro Montanari, Formigine (Modena) (IT)

Correspondence Address: PEARNE & GORDON LLP, 1801 EAST 9TH STREET, SUITE 1200, CLEVELAND, OH, 44114-3108, US

(73) Assignee: F.S.A. S.R.L., Busnago (Milano) (IT)

(21) Appl. No.: 11/587,517

(22) PCT Filed: Apr. 29, 2005
(86) PCT No.: PCT/IB05/01199

§ 371 Date: Oct. 24, 2006

(30) Foreign Application Priority Data
May 6, 2004 (IT) MO2004A000108

(51) Int. Cl. B62M 9/12

(52) U.S. Cl. 474/80

(57) ABSTRACT

A derailleur (10) is predisposed to translate a drive change (11) between at least two gears (12) rotating about a rotation axis (y). The derailleur (10) is mobile in one direction in rotation with respect to the bicycle frame by action of a cable (14) which by command is made to exert a traction force. In an opposite direction the derailleur (10) rotates, also by action of the cable (14), which is loosened by command, and by action of elastic means. The gear change comprises a retaining device (2) predisposed to maintain the derailleur (10), in absence of a command, in a predetermined angular position. The retaining device (2) comprises a fixed portion and a mobile portion. The fixed portion is associable to the bicycle frame, the mobile portion is solidly associable to the derailleur (10). The fixed portion, in determined angular positions of the derailleur (10), removably connects to the mobile portion.

### TECHNICAL FIELD

The invention relates to the field of gears for bicycles.

### BACKGROUND ART

Known-type bicycle gears comprise a derailleur provided with an element for guiding a bicycle transmission chain. The derailleur is connected to the frame of the bicycle and is predisposed to rotate, on command, with respect to the bicycle frame in order to translate the chain between a plurality of coaxial gears on a wheel of the bicycle rotating about an axis thereof. The axis, in the case of a front gear change, is the rotation axis of the central movement, i.e. the pedals, while in a posterior change the rotation axis is that of the rear wheel.

The derailleur comprises an arm to which the chain guide element is associated. The arm is typically constituted by a four-bar hinge in which two parallel sides are defined respectively by a connection element to the bicycle frame and an element to which the chain guide element is connected. The two arms of the four-bar hinge, which connect the frame connection element and the chain guide element, are arranged in such a way as to allow displacements of the chain guide element in a transversal direction with respect to the drive chain.

The chain guide element is defined by a cage which, in the case of a rear change, supports two cogwheels lying on a plane that is perpendicular to the rotation axis of the gears.

The function of the four-bar hinge, or more generally the arm supporting the chain guide element, is to guarantee that the guide element of the drive chain can displace parallel to itself with respect to the bicycle frame. In particular, the chain guide element displaces, maintaining a constant orientation of the connection element with the bicycle frame.

The displacements of the chain guide element are determined by means of a cable connected by an end thereof to at least one of the arms of the four-bar hinge, and connected at another end thereof to a command, usually associated to the bicycle frame, which enables the cable to be pulled or released by winding it or unwinding it onto or off a drum. By creating traction on the cable a rotation of the arms of the four-bar hinge is determined with respect to the relative hinging points with the connection element, while on releasing the tension on the cable, a spring induces an opposite rotation of the arms. The derailleur is mobile in a plurality of angular positions in each of which the drive chain enmeshes with a gear. Each angular position is defined by a traction or release of a predetermined length of the gear change activating cable. For this purpose the command by which the pulling or releasing action is performed is provided with a selector mechanism which impresses on the drum the cable winds on a rotation by a predetermined angle for each action performed on the command. The mechanism generally comprises a rotary transmission including singly-directed retaining elements which enable a rotation of the drum to be made, maintaining the drum in the position reached in the absence of further commands.

Known-type commands exhibit several drawbacks. The selector mechanism is arranged internally of the command, which is therefore rather complex in construction. Indeed a large number of components are needed to realised the selector mechanism. The synchronisation of the drum rotation with the rotation of the derailleur is done by the cable and the sheath thereof, which are provided with a degree of elasticity. There is in fact a certain amount of play between the two elements. In order to perform the synchronisation, once the cable is joined up to the command and the derailleur, it is necessary to position the drum and the derailleur in a “zero” initial position. This operation is performed by varying the position of one of the ends of the sheath by means of a screw adjustment. By effectively “lengthening” the sheath the cable is tensed, and by effectively “shortening” the sheath the cable is loosened. This is a somewhat laborious operation which can be performed only with the bicycle mounted on a special support, raised from the ground and with the back wheel free to rotate. Once calibrated, further adjustments will be necessary as loads and therefore deformations which the various elements are subject to are greater when the bicycle is at work, and a pre-calibration with the cycle at rest is very difficult to achieve. Should there be a tiny variation in the axial distance between the various gears, a new gear change mechanism adjustment operation is required.

The main aim of the present invention is to provide a gear change mechanism for a bicycle which will obviate the drawbacks of the prior art.

An advantage of the invention is that the gear change is extremely precise and reliable during operation.

A further advantage thereof is that it enables use of extremely simple and economical gear controls.

A further advantage is that the gear change is very simply and rapidly adjusted.

### DISCLOSURE OF INVENTION

Further characteristics and advantages will better emerge from the following detailed description of a gear change for a bicycle, made herein below with reference to the accompanying figures of the drawings, given purely by way of a non-limiting example, in which:

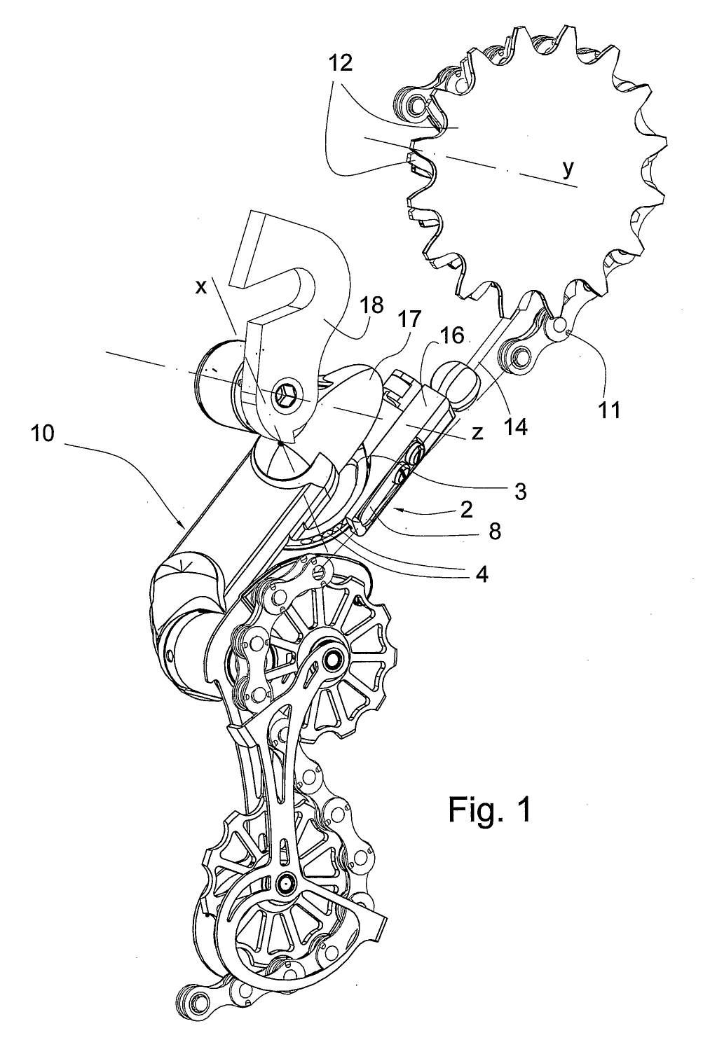

FIG. 1 is a perspective view in partial section of a gear change of the present invention;

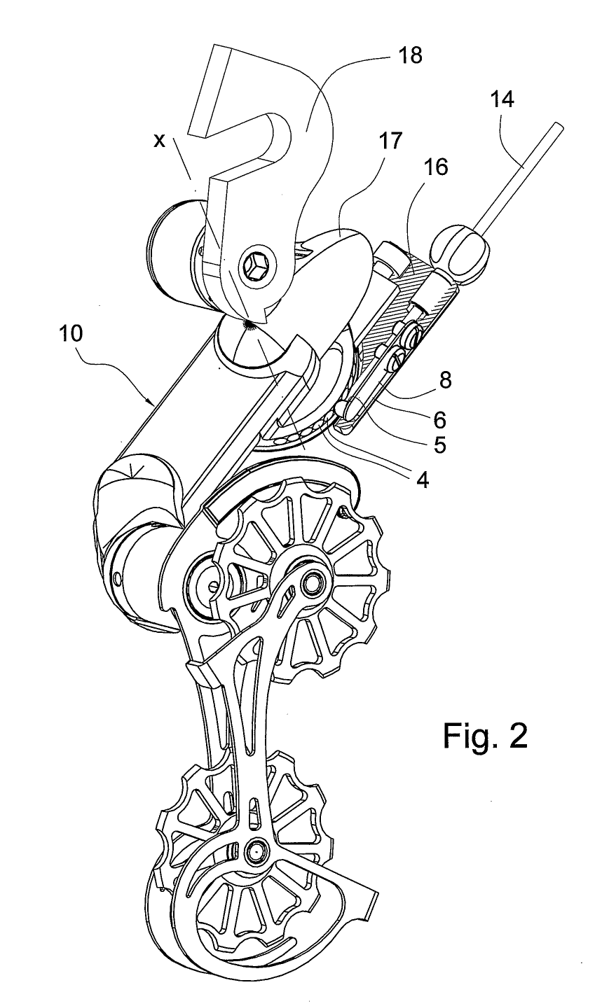

FIG. 2 is the same perspective view as in FIG. 1, with some parts sectioned;

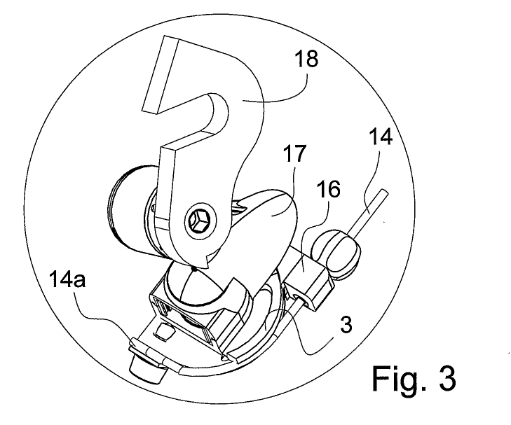

FIG. 3 is a detail of the gear change mechanism of the invention with some parts removed in order better to evidence others.

With reference to the figures of the drawings, the gear change of the present invention comprises a derailleur 10, associable to a frame of a bicycle, predisposed to translate a transmission chain 11 between at lest two gears 12 rotating about a first rotation axis y. The chain 11 is represented schematically, in a broken line, in the figures for reasons of simplicity. The rotation axis can be the axis of the rear wheel, if the gear change is posterior, or can be central i.e. the rotation axis of the pedals, should the gear change be fitted to the clanger. The solution illustrated in the present description relates, by way of an example, to a rear wheel-mounted gear change.

In greater detail, the derailleur 10 comprises a hook portion 18, solidly associable to the bicycle frame, and a connecting portion 17, which rotates with respect to the hook portion 18 about a second rotation axis z. In the illustrated solution, i.e. a rear wheel mounted gear change, the second rotation axis z is parallel to the first rotation axis y. In the case of a front mounted gear change, the second rotation axis z is transversal with respect to the first rotation axis y.

On command the derailleur 10 is mobile in rotation, with respect to the bicycle frame, about a main axis x between at least two angular positions, in each of which the drive chain 11 enmeshes with a gear 12. In one direction the derailleur 10 is mobile in rotation by means of a cable 14 which at an end 14a thereof is solidly constrained to the derailleur 10 and is subjected to a traction force by means of a command of known type and not illustrated in the figures. In an opposite direction, the derailleur is mobile in rotation by means of a cable 14 which is loosened by means of the above-mentioned command, and also by elastic elements of known type and not represented in the figures of the drawings. The gear change comprises a retaining device 2, predisposed to keep the derailleur 10, in the absence of commands, in one of the at least two positions. The retaining device 2 comprises a fixed portion and a mobile portion. The fixed portion is associable to the bicycle frame, solid in rotation about the main axis x of the derailleur 10, while the mobile portion is solidly associable to the derailleur 10. The fixed portion, in the at least two angular positions of the derailleur 10, is removably connected to the mobile portion.

The mobile portion, associable to the derailleur 10, comprises a cylindrical sector 3, which has at a lateral surface thereof at least two chambers 4. The cylindrical sector 3 is coaxial to the main axis x of the derailleur 10. the cylindrical sector 3 exhibits, on a lateral surface thereof, a channel which develops coaxially to the cylindrical sector 3 itself. The channel is predisposed to receive at least one tract of the cable 14 which is adjacent to the end 14a that is solidly constrained to the derailleur 10. The cable 14, over a tract of its length close to the end 14a, is arranged tangentially in contact with the cylindrical sector 3.

The fixed portion, associable to the bicycle frame solidly in rotation about the main axis x of the derailleur 10, comprises a shaped element 5 which is mobile within a housing 6 that is afforded in an appendage 16 of the connecting portion 17. The housing 6 exhibits an elongate shape and is open at an end that is close to a lateral surface of the cylindrical sector 3. Internally of the housing 6 elastic means are arranged to push the shaped element 5 into contact with the lateral surface of the cylindrical sector 3.

In a preferred embodiment, the shaped element 5 is a sphere. The elastic means are a flat spring 8 which at an end is in contact with the sphere. The flat spring 8 is arranged parallel to the housing 6 and at an end thereof is constrained to the appendage 16 of the connecting portion 17, while at another end it is located in contact with the shaped element 5 in order to exert, on the shaped element 5, a force directed radially with respect to the cylindrical sector 3. In some determined angular positions of the derailleur 10, the shaped element 5, or sphere, engages at least partially in the chambers 4 arranged on the lateral surface of the cylindrical sector 3 by effect of the push exerted by the flat spring 8. The force with which the sphere 5 is pressed towards a chamber 4 is sufficient, in the absence of commands of the cable 14, to maintain the derailleur 10 in a corresponding angular position with respect to the main rotation axis x. In order to impose a rotation in a given direction to the derailleur 10 the cable must be activated 14 in traction up until it exerts a force which is superior to the force determined by the engagement of the sphere 5 in a chamber 4. To impose an opposite rotation on the derailleur 10, the cable 14 is loosened; the elastic means of known type, by means of which the derailleur 10 is mobile in rotation, are of such a size as to exert a couple, with respect to the main axis x, which is sufficient to overcome the couple determined by the engagement of the sphere 5 in a chamber 4. To establish an initial, or zero position of the derailleur 10, the appendage 16 is slidable with respect to the connecting portion 17, either towards or away from the cylindrical sector 3 along a winding direction of the cable 14 on the cylindrical sector 3. A sliding of the appendage 16 is equivalent, in practice, to a modification of the cable length 14; by nearing the appendage 16 to the cylindrical sector 3 the derailleur 10 rotates in a direction, while by distancing the appendage 16 from the cylindrical sector 3, the derailleur 10 rotates in an opposite direction. Thus, by sliding the appendage 16, a calibration of the initial derailleur position is possible. The appendage 16 is slidable with respect to the connecting portion 17 by means of a device of known type constituted by a screw which is axially constrained to the appendage 16, and by a nut, solidly connected to the connecting portion 17.

The bicycle gear change mechanism of the invention offers important advantages.

Firstly, it is precise and reliable. As the retaining device is associated to the derailleur, the gear change enables the use of extremely simple and economical commands which are limited to winding-on and off the cable for tracts of the length thereof which do not go above a determined amount. The calibration of the gear change is very simple and rapid as the retaining device and the derailleur are not separated by the presence of the cable and the sheath. Thus the position of the derailleur is determined directly by the retaining device, with no influence due to the elasticity of the cable and sheath.

1. A bicycle gear mechanism, comprising a derailleur (10), associable to a bicycle frame, predisposed to translate a drive chain (11) between at least two gears (12) rotating about a rotation axis (y), the derailleur (10) being on command mobile in rotation about a main axis (x) with respect to the bicycle frame between at least two angular positions, in each of which positions the drive chain (11) enmeshes with a gear (12), the derailleur (10) being mobile in rotation in one direction by action of a cable (14) which is caused to exert a traction force on the derailleur (10), and being mobile in another direction by action of the cable (14) which is on command caused to release a traction on the derailleur (10), wherein the gear mechanism comprises a retaining device (2) which in absence of a command is predisposed to keep the derailleur (10) in one of at least two positions, the retaining device (2) comprising a fixed portion and a mobile portion, the fixed portion being associable to the bicycle frame solidly in rotation about the main axis (x) of the derailleur (10), the mobile portion being solidly associable to the derailleur (10); the fixed portion, at the at least two angular positions of the derailleur (10), removably connecting to the mobile portion.

2. The gear change mechanism of claim 1, wherein the mobile portion, associable to the derailleur (10), comprises a cylindrical sector (3) which is coaxial to the main axis (x) of the derailleur (10), which cylindrical sector bears at least two chambers (4) on a lateral surface thereof.

3. The gear change mechanism of claim 2, wherein the fixed portion, solidly associable to the bicycle frame, comprises a shaped element (5) which is mobile internally of an elongate housing (6) which is open at an end thereof which is proximal to the lateral surface of the cylindrical sector (3), elastic means being arranged internally of the housing (6) in order to push the shaped element (5) into contact with the lateral surface of the cylindrical sector (3).

4. The gear change mechanism of claim 3, wherein the shaped element (5) is defined by a sphere, the elastic means being defined by a flat spring (8) which at an end thereof is placed in contact with the sphere.

5. The gear change mechanism of claim 1, wherein the derailleur (10) comprises a hook portion (18), solidly associable to the bicycle frame, and a connecting portion (17) which rotates with respect to the hook portion (18) about a second rotation axis (z), wherein the housing (6) is made in an appendage (16) of the connecting portion (17), the flat spring (8) being arranged parallel to the housing (6), the flat spring (8) being constrained at an end thereof to the appendage (16) of the connecting portion (17), being constrained at another end thereof being placed in contact with the shaped element (5) in order to exert a force on the shaped element (5) which force is directed radially with respect to the cylindrical sector (3).

6. The gear change mechanism of claim 5, wherein the appendage (16) is slidable with respect to the connecting portion (17) both in a nearing and in a distancing direction with respect to a winding direction of the cable (14) onto the cylindrical sector (3).

7. The gear change mechanism of claim 1, wherein the cylindrical sector (3) exhibits, on a lateral surface thereof, a channel which develops coaxially to the cylindrical sector (3), the channel being predisposed to receive at least a tract of the cable (14).
